(19) United States
(12) Patent Application Publication
(10) Pub. No.: US 2023/0154039 A1
(43) Pub. Date: May 18, 2023

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventors: Hiroshi HASHIMOTO, Tokyo (JP); Soma SHIRAISHI, Tokyo (JP); Takami SATO, Tokyo (JP); Yu NABETO, Tokyo (JP); Kan ARAI, Tokyo (JP); Kei SHIBUYA, Tokyo (JP); Azusa FURUKAWA, Tokyo (JP); Ken HANAZAWA, Tokyo (JP); Makiko AKIGUCHI, Tokyo (JP)

(73) Assignee: NEC Corporation, Minato-ku, Tokyo (JP)

(21) Appl. No.: 17/919,582

(22) PCT Filed: Apr. 24, 2020
(86) PCT No.: PCT/JP2020/017716

§ 371 Date: Oct. 18, 2022

(51) Int. Cl. G06T 7/73; G06T 7/20

(52) U.S. Cl. CPC G06T 7/73; G06T 7/20

(57) ABSTRACT

The present invention provides a processing apparatus (10) including: an acquisition unit (11) that acquires an image of a product held in a hand of a customer; an image analysis unit (12) that generates time-series information on a position of the product, based on the image; a determination unit (13) that determines whether the customer has performed a specific action for the product, based on a movement status of the product indicated by the generated time-series information; and a registration unit (14) that registers that the customer has performed the specific action.

### TECHNICAL FIELD

The present invention relates to a processing apparatus, a processing method, and a program.

### BACKGROUND ART

Patent Document 1 discloses a customer action analysis method for determining a product viewed by a customer by tracking a line-of-sight movement of the customer.

Non-Patent Documents 1 and 2 disclose a store system in which settlement processing (such as product registration and payment) at a cash register counter is eliminated. In the technique, a product held in a hand of a customer is recognized based on an image generated by a camera for photographing inside a store, and settlement processing is automatically performed based on a recognition result at a timing when the customer goes out of the store.

### RELATED DOCUMENT

### Patent Document

[Patent Document 1] International Publication No. WO2015/033577

### Non-patent Document

[Non-Patent Document 1] Takuya MIYATA, “Structure of Amazon Go Supermarket without Cash Register to be Achieved by ‘Camera and Microphone’”, [online], Dec. 10, 2016, [search on Dec. 6, 2019], the Internet <URL:https//www.huffingtonpost.jp/tak-miyata/amazon-go_b_13521384.html>

[Non-Patent Document 2] “NEC, Opened Cash Registerless Store ‘NEC SMART 0 STORE’ in Main Office—Utilization of Face Recognition, Settlement Simultaneously when Leaving Store”, [online]. Feb. 28, 2020, [search on Mar. 27, 2020], the Internet <URL:https://japan.cnet.com/article/35150024/>

### DISCLOSURE OF THE INVENTION

### Technical Problem

A technique for analyzing an action of a customer in a store has been desired for a preference survey of a customer, a marketing research, and the like. Analyzing an action of a customer in a store by various methods leads to acquisition of an advantageous effect that a range of an analyzable content is expanded and accuracy is improved. An object of the present invention is to provide a novel method for analyzing an action of a customer in a store.

### Solution to Problem

The present invention provides a processing apparatus including: an acquisition unit that acquires an image of a product held in a hand of a customer; an image analysis unit that generates time-series information on a position of the product, based on the image;

a determination unit that determines whether the customer has performed a specific action for the product, based on a movement status of the product indicated by the generated time-series information; and

a registration unit that registers that the customer has performed the specific action.

Further, the present invention provides a processing method including, by a computer:

acquiring an image of a product held in a hand of a customer;

generating time-series information on a position of the product, based on the image;

determining whether the customer has performed a specific action for the product, based on a movement status of the product indicated by the generated time-series information; and

registering that the customer has performed the specific action.

Further, the present invention provides a program causing a computer to function as:

an acquisition unit that acquires an image of a product held in a hand of a customer;

an image analysis unit that generates time-series information on a position of the product, based on the image;

a determination unit that determines whether the customer has performed a specific action for the product, based on a movement status of the product indicated by the generated time-series information; and

a registration unit that registeres that the customer has performed the specific action.

### Advantageous Effects of Invention

The present invention achieves a novel method for analyzing an action of a customer in a store.

### BRIEF DESCRIPTION OF DRAWINGS

FIG. 1 is a diagram illustrating one example of a hardware configuration of a processing apparatus according to the present example embodiment.

FIG. 2 is one example of a functional block diagram of the processing apparatus according to the present example embodiment.

FIG. 3 is a diagram illustrating an installation example of a camera according to the present example embodiment.

FIG. 4 is a diagram illustrating an installation example of a camera according to the present example embodiment.

FIG. 5 is a diagram illustrating a processing content of the processing apparatus according to the present example embodiment.

FIG. 6 is a diagram schematically illustrating one example of information to be processed by the processing apparatus according to the present example embodiment.

FIG. 7 is a diagram schematically illustrating one example of information to be processed by the processing apparatus according to the present example embodiment.

FIG. 8 is a diagram schematically illustrating one example of information to be processed by the processing apparatus according to the present example embodiment.

FIG. 9 is a flowchart illustrating one example of a flow of processing of the processing apparatus according to the present example embodiment.

FIG. 10 is a flowchart illustrating one example of a flow of processing of the processing apparatus according to the present example embodiment.

### DESCRIPTION OF EMBODIMENTS

### First Example Embodiment

### “Overview”

A processing apparatus according to a present example embodiment is configured in such a way that, when an image generated by a camera for photographing a product held in a hand of a customer is acquired, time-series information on a position of the product (product held in a hand of a customer) is generated based on the image, and an action performed for the product (product held in a hand of a customer) by a customer is determined based on a movement status of the product indicated by the time-series information on the position. According to the processing apparatus, a novel method for analyzing an action of a customer in a store is achieved.

### “Hardware Configuration”

Next, one example of a hardware configuration of the processing apparatus is described.

Each functional unit of the processing apparatus is achieved by any combination of hardware and software mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

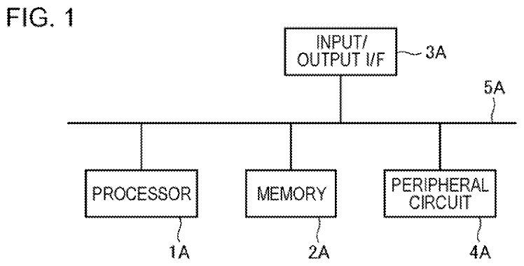

FIG. 1 is a block diagram illustrating a hardware configuration of the processing apparatus. As illustrated in FIG. 1, the processing apparatus includes a processor 1A, a memory 2A, an input/output interface 3A, a peripheral circuit 4A, and a bus 5A. The peripheral circuit 4A includes various modules. The processing apparatus may not include the peripheral circuit 4A. Note that, the processing apparatus may be constituted of a plurality of apparatuses that are physically and/or logically separated, or may be constituted of one apparatus that is physically and/or logically integrated. In a case where the processing apparatus is constituted of a plurality of apparatuses that are physically and/or logically separated, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on these arithmetic operation results.

### “Functional Configuration”

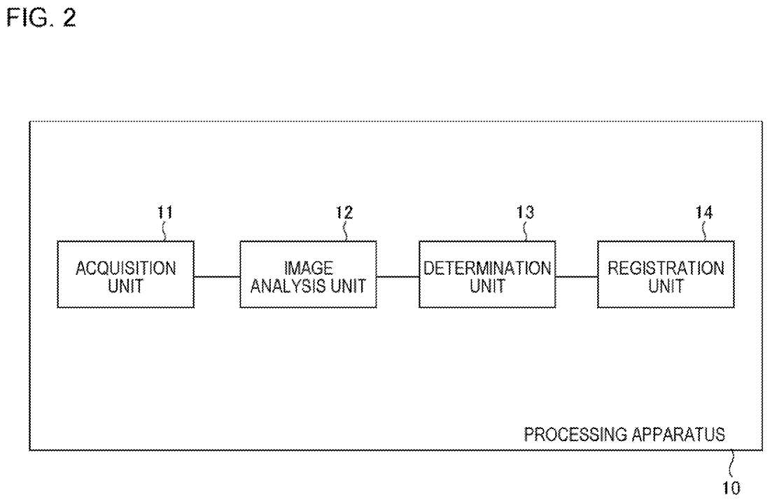

FIG. 2 illustrates one example of a functional block diagram of a processing apparatus 10. As illustrated in FIG. 2, the processing apparatus 10 includes an acquisition unit 11, an image analysis unit 12, a determination unit 13, and a registration unit 14.

The acquisition unit 11 acquires an image of a product held in a hand of a customer, which is generated by a camera for photographing the product held in the hand of the customer.

Herein, a camera is described. In the present example embodiment, a plurality of cameras (two or more cameras) are installed in a store in such a way that a product held in a hand of a customer can be photographed in a plurality of directions and at a plurality of positions. For example, a plurality of cameras may be installed at a position and in an orientation in which a product taken out of each product display shelf, and held in a hand of a customer located in front of each product display shelf, is photographed for each product display shelf A camera may be installed on a product display shelf, may be installed on a ceiling, may be installed on a floor, may be installed on a wall surface, or may be installed at another location. Note that, an example in which a camera is installed for each product display shelf is merely one example, and the present example embodiment is not limited thereto.

A camera may photograph a moving image constantly (e.g., during business hours), or may continuously photograph a still image at a time interval larger than a frame interval of a moving image, or these photographing operations may be performed only during a time when a person present at a predetermined position (such as in front of a product display shelf) is detected by a human sensor or the like.

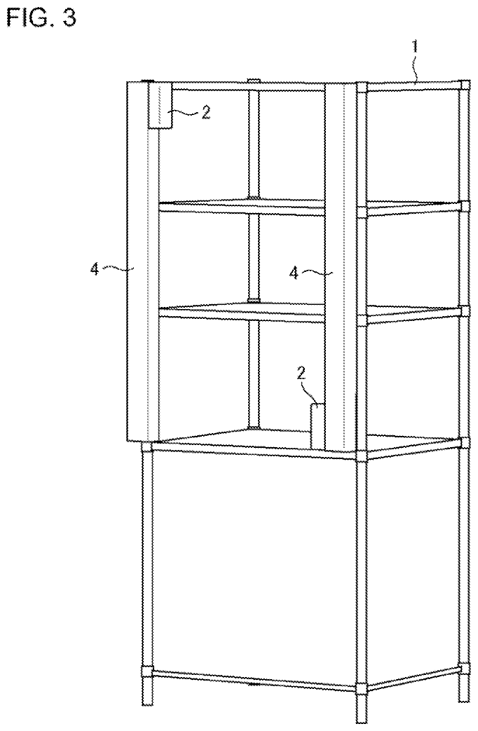

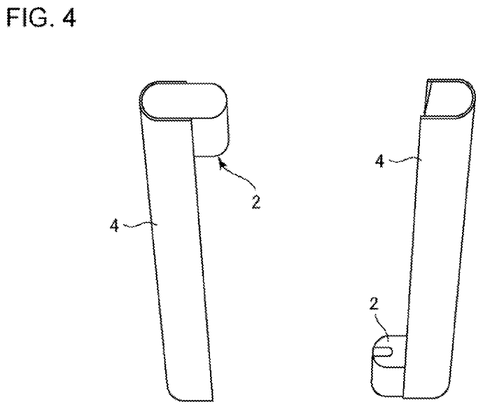

Herein, one example of camera installation is described. Note that, a camera installation example described herein is merely one example, and the present example embodiment is not limited thereto. In an example illustrated in FIG. 3, two cameras 2 are installed for each product display shelf 1. FIG. 4 is a diagram in which a frame 4 in FIG. 3 is extracted. A camera 2 and an illumination are provided for each of two components constituting the frame 4.

The illumination includes a light emitting unit and a cover. A light irradiation surface of the illumination extends in one direction. The illumination mainly irradiates light in a direction orthogonal to an extending direction of the light irradiation surface. The light emitting unit includes the light emitting element such as a LED, and irradiates light in a direction in which the illumination is not covered by the cover. Note that, in a case where the light emitting element is a LED, a plurality of LEDs are aligned in a direction (up-down direction in the figure) in which the illumination extends.

Further, the camera 2 is provided at one end of a component of the linearly extending frame 4, and has a photographing range in a direction in which light of the illumination is irradiated. For example, in a component of the left-side frame 4 in FIG. 4, the camera 2 has a photographing range in a range extending downward, downward and forward, obliquely right downward, and obliquely right downward and forward. Further, in a component of the right-side frame 4 in FIG. 4, the camera 2 has a photographing range in a range extending upward, upward and forward, obliquely left upward, and obliquely left upward and forward.

As illustrated in FIG. 3, the frame 4 is mounted on a front surface frame (or a front surface of a side wall on both sides) of the product display shelf 1 constituting a product placement space. One of components of the frame 4 is mounted on one of the front surface frames in an orientation in which the camera 2 is located at a lower position. The other of the components of the frame 4 is mounted on the other of the front surface frames in an orientation in which the camera 2 is located at an upper position. Further, the camera 2 mounted on one of the components of the frame 4 photographs a range extending upward, upward and forward, obliquely left upward, and obliquely left upward and forward in such a way that an opening portion of the product display shelf 1, and a front thereof (customer side located in front of the product display shelf 1) is included in a photographing range. On the other hand, the camera 2 mounted on the other of the components of the frame 4 photographs a range extending downward, downward and forward, obliquely right downward, and obliquely right downward and forward in such a way that the opening portion of the product display shelf 1, and a front thereof (customer side located in front of the product display shelf 1) are included in a photographing range. This configuration allows the two cameras 2 to photograph an entire range of the opening portion of the product display shelf 1, and the front of the product display shelf 1 (customer side located in front of the product display shelf 1). Consequently, it becomes possible to photograph, by the two cameras 2, a product taken out of the product display shelf 1, a customer located in front of the product display shelf 1, a product held in a hand of the customer, and the like.

Referring back to FIG. 2, the image analysis unit 12 generates time-series information and the like on a position of a product held in a hand of a customer, based on an image acquired by the acquisition unit 11. The image analysis unit 12 performs product recognition processing, tracking processing, and position computation processing. In addition to the above, the image analysis unit 12 may perform customer analysis processing. In the following, each processing is described.

### Product Recognition Processing

In the processing, the image analysis unit 12 analyzes an image, and recognizes a product present within the image. A technique for recognizing a product present within an image is widely known, and the image analysis unit 12 can adopt any available technique. In the following, one example is described.

First, the image analysis unit 12 detects an object present within an image. Note that, the image analysis unit 12 may detect a hand of a person within an image, and detect an object in contact with the hand of the person. Since an object detection technique, and a technique for detecting a hand of a person are widely known, description thereof is omitted herein.

Subsequently, the image analysis unit 12 recognizes a product present within an image by collating between a feature value of an external appearance of an object detected from the image, and a feature value of an external appearance of each of a plurality of products registered in advance.

For example, a class classifier for recognizing a product within an image may be generated, in advance, by machine learning based on training data in which an image of each of a plurality of products, and identification information (label) of each product are associated with each other. Further, the image analysis unit 12 may achieve product recognition by inputting an image acquired by the acquisition unit 11 to the class classifier. In addition to the above, the above-described collation and product recognition may be achieved by pattern matching. A processing target by the class classifier or pattern matching may be an image itself acquired by the acquisition unit 11, or may be an image in which a partial region where the above-described detected object is present is cut out from the image.

### Tracking Processing

In the processing, the image analysis unit 12 tracks a position, within an image, of a product recognized by product recognition processing. A technique for tracking a position, within an image, of an object present within the image is widely known, and the image analysis unit 12 can adopt any available technique.

### Position Computation Processing

In the processing, the image analysis unit 12 computes a position of a product recognized by product recognition processing, and a position of a product being tracked by tracking processing. A position of a product is indicated by, for example, a coordinate in a three-dimensional coordinate system. In a case where a product (same subject) held in a hand of a customer is photographed, by a plurality of cameras whose installation positions are fixed and whose mutual positional relations are known in advance, at positions different from each other and in orientations different from each other, a position of the product within a three-dimensional space can be computed based on an image generated by the plurality of cameras. Time-series information on a position of a product held in a hand of a customer is generated by storing position information of the recognized product in time-series order.

### Customer Analysis Processing

In the processing, the image analysis unit 12 can estimate an attribute of a customer, based on an external appearance (example: face) of the customer included in an image. The attribute to be estimated can be estimated from an image, such as gender, age, and nationality, and is information useful in a preference survey of a customer, and a marketing research.

In addition to the above, in the processing, the image analysis unit 12 may recognize a customer included in an image. In this case, identification information (such as a customer number, a name, and an address) of each of a plurality of customers, and a feature value of an external appearance (such as a feature value of a face) of a customer are stored in advance in a predetermined location (such as a center system, or a store system) in association with each other. Further, the image analysis unit 12 recognizes who is a customer holding a product in a hand of the customer by collating between a feature value of an external appearance of the customer extracted from an image photographed in a store, and a feature value of an external appearance of a customer stored in advance.

The determination unit 13 determines whether a customer has performed a specific action for a product, based on a movement status of the product indicated by time-series information on a position of the product.

The movement status is information computable from time-series information on a position of a product, and, for example, time-series information (timewise change) of a moving velocity, time-series information (timewise change) of an acceleration, time-series information (timewise change) of a change amount of a position, a statistical value (such as an average value, a maximum value, a minimum value, a mode, and a median) of these pieces of time-series information, time-series information (timewise change) of a statistical value of these pieces of time-series information for each unit time, and the like are exemplified.

A plurality of kinds of actions which may be performed for a product held in a hand of a customer are defined in advance. Further, reference information in which a feature of a movement status of a product (product held in a hand of a customer) when the customer is performing each action is generated for each defined action, and stored in the processing apparatus 10. Further, in a case (case where a first condition is satisfied) where “a feature of a movement status of a product (product held in a hand of a customer) when the customer is performing each action”, which is indicated by the above-described reference information, is included in a movement status of a product indicated by time-series information on a position of a product generated by the image analysis unit 12, the determination unit 13 determines that an action associated with the feature has been performed for the product.

Herein, one example of processing of the determination unit 13 is described. In the example, the determination unit 13 generates time-series information on a moving velocity of a product, based on time-series information on a position of the product. Further, in a case where “a first pattern in which a first time period when a moving velocity of a product is equal to or more than a reference value (design matter) holds therebetween a second time period when a moving velocity of the product is less than the reference value” is included in the time-series information on the moving velocity of the product, the determination unit 13 determines that a customer has performed an action of visually recognizing an external appearance of the product held in a hand of the customer.

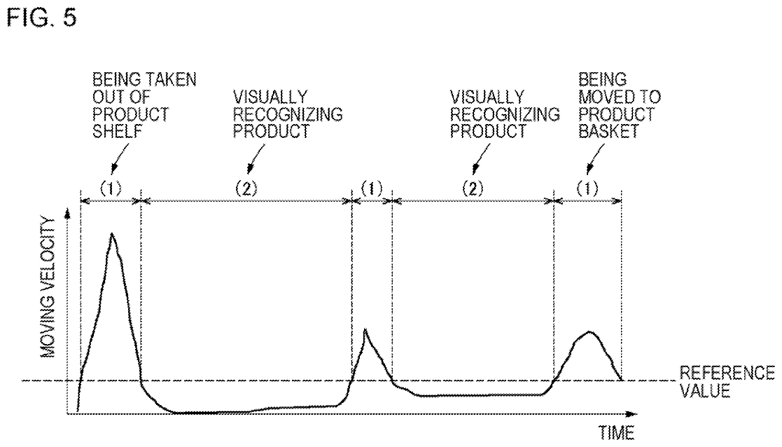

FIG. 5 schematically illustrates one example of time-series information on a moving velocity of a product including the first pattern. A horizontal axis denotes time, and A vertical axis denotes a moving velocity. A time period (1) is the first time period when a moving velocity of a product is equal to or more than a reference value. A time period (2) is the second time period when a moving velocity of the product is less than the reference value.

In the first time period, a product is moving at a relatively fast velocity. In this time period, it is estimated that a customer has performed an action of taking out a product from a product display shelf, returning a product to a product display shelf, moving while holding a product in a hand, or putting, into a basket, a product held in a hand. Further, in the second time period interposed between the first time periods as described above, it is estimated that a customer has performed an action of visually recognizing an external appearance of a product held in a hand of the customer, for example, an action of reading description of a product, or checking an external appearance of a product.

In addition to the above, in a case where “a second pattern in which the first time period when a moving velocity of a product is equal to or more than a reference value (design matter) holds therebetween the second time period when a moving velocity of the product is less than the reference value, and a length of the second time period is equal to or more than a reference value” is included in the time-series information on the moving velocity of the product, the determination unit 13 can determine that a customer has hesitated to determine whether to purchase the product held in a hand of the customer. A difference between the first pattern and the second pattern is whether a condition on a length of the second time period is included.

As described above, in the second time period interposed between the first time periods, it is estimated that a customer has performed an action of visually recognizing an external appearance of a product held in a hand of the customer, for example, an action of reading description of a product, or checking an external appearance of a product. Further, in a case where a length of the second time period as described above is relatively long (case where the length is equal to or more than a reference value), it is estimated that a customer has hesitated to determine whether to purchase the product held in a hand of the customer during the second time period.

In addition to the above, in a case where the above-described first pattern or second pattern is not included in time-series information on a moving velocity of a product, the determination unit 13 can determine that a customer has put, into a shopping basket, a product taken out of a product display shelf without visually recognizing an external appearance.

Referring back to FIG. 2, the registration unit 14 registers that a customer has performed a specific action.

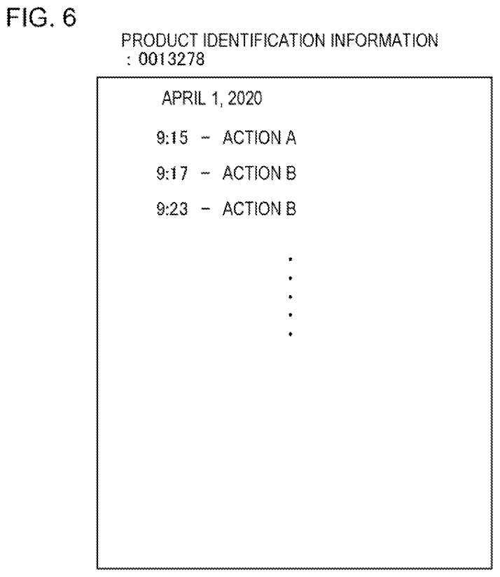

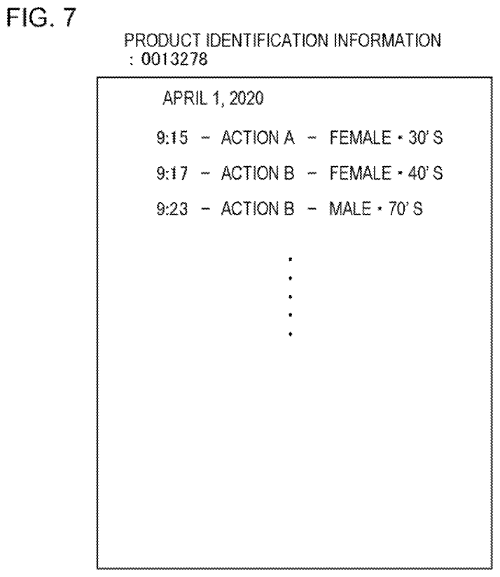

For example, as illustrated in FIG. 6, the registration unit 14 may register a history on an action of a customer with respect to each product, for each product (for each piece of product identification information). In the example illustrated in FIG. 6, an action performed by a customer with respect to each product, and a date and a time when the customer has performed each action are registered for each piece of product identification information. Note that, in a case where attribute information of a customer is estimated by customer analysis processing by the image analysis unit 12, as illustrated in FIG. 7, the registration unit 14 may further register the attribute information of the customer who has performed each action in association.

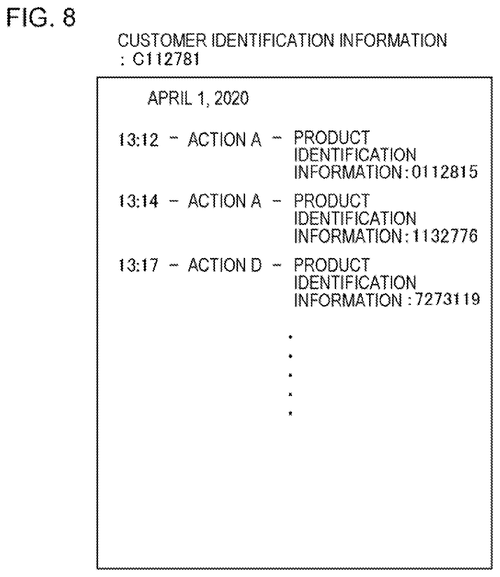

In addition to the above, in a case where customer identification information is determined by customer analysis processing by the image analysis unit 12, as illustrated in FIG. 8, the registration unit 14 may register a history on an action performed by each customer, for each customer (for each piece of customer identification information). In the example illustrated in FIG. 8, an action performed by a customer, a product (product identification information) being a target for each action, and a date and a time when a customer has performed each action are registered for each piece of customer identification information.

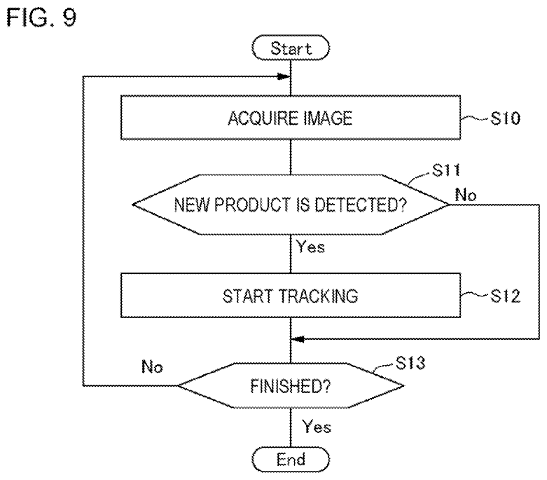

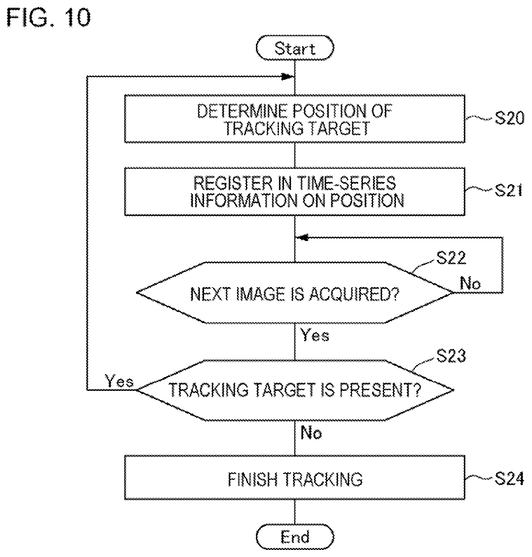

Next, one example of a flow of processing of the processing apparatus 10 is described by using a flowchart in FIGS. 9 and 10.

The flowchart in FIG. 9 illustrates processing in which a tracking target is detected by analyzing an image until tracking is started.

As illustrated in FIG. 9, when the acquisition unit 11 acquires a new image as an analysis target (S10), the image analysis unit 12 analyzes the image, and performs the above-described product recognition processing. Then, in a case where a new product (product different from a product being tracked) is detected within the image (Yes in S11), the image analysis unit 12 starts tracking a position of the newly detected product within the image (S12). Thereafter, in a case where an input to finish the processing is not present (No in S13), the processing apparatus 10 returns to S10, and repeats similar processing.

On the other hand, in a case where a new product (product different from a product being tracked) is not detected within the image (No in 511), and in a case where an input to finish the processing is not present (No in S13), the processing apparatus 10 returns to S10, and repeats similar processing.

Note that, the acquisition unit 11 acquires in time-series order, as an analysis target, a plurality of images generated by a camera in time-series order. The acquisition unit 11 may acquire an image generated by a camera by real-time processing, or may acquire in an order of generation from among a plurality of images generated/accumulated in advance.

Next, the flowchart in FIG. 10 illustrates processing to be performed for a product of which tracking has been started.

First, the image analysis unit 12 performs the above-described position computation processing for a product of which tracking has been started, and determines a position of the product (tracking target) (S20). Then, the image analysis unit 12 registers, in time-series information on a position of the product, information indicating the determined position (S21).

When the acquisition unit 11 acquires a next image, as an analysis target (Yes in S22), the image analysis unit 12 determines whether the product (tracking target) is present within the newly acquired image by the above-described tracking processing (S23).

In a case where the product is present (Yes in S23), the image analysis unit 12 performs the above-described position computation processing for the product (tracking target), and determines a position of the product (S20). Then, the image analysis unit 12 registers, in time-series information on a position of the product, information indicating the determined position (S21).

On the other hand, in a case where the product is not present (No in S23), the image analysis unit 12 finishes tracking of the product (tracking target) (S24). Note that, in a case where the image analysis unit 12 cannot detect a tracking target within a predetermined number of sequential images, the image analysis unit 12 may finish tracking.

The processing apparatus 10 repeats the above-described processing until tracking is finished.

For example, by processing as described above, time-series information on a position of a product held in a hand of a customer is generated. At any timing after generation of the time-series information on the position of the product held in the hand of the customer, the determination unit 13 determines whether the customer has performed a specific action for the product, based on a movement status of the product indicated by the time-series information on the position of the product. Further, the registration unit 14 registers that the customer has performed the specific action.

### “Modification Example”

The determination unit 13 may detect, after a customer has taken out a product from a product display shelf, that the customer has returned the product to the product display shelf, based on time-series information on a position of the product held in a hand of the customer. For example, a position of a product display shelf is defined in a three-dimensional coordinate system for indicating a position of a product. Further, the determination unit 13 may detect that the customer has performed the action (of returning the product to the product display shelf after picking up the product) for a product held in the hand of the customer, based on a relative positional relation between a position of the product being changed within the three-dimensional coordinate system, and the position (fixed) of the product display shelf defined in advance.

### “Advantageous Effect”

As described above, the processing apparatus 10 according to the present example embodiment generates time-series information on a position of a product held in a hand of a customer, and determines an action performed for the product (product held in the hand of the customer) by the customer, based on a movement status of the product indicated by the time-series information on the position. According to the processing apparatus, a novel method for analyzing an action of a customer in a store is achieved.

Further, in a store that has introduced “a store system in which settlement processing (such as product registration and payment) at a cash register counter is eliminated” as disclosed in Non-Patent Documents 1 and 2, a camera for photographing a product held in a hand of a customer is installed in the store to recognize the product held in the hand of the customer. In the processing apparatus 10 according to the present example embodiment in which an action of a customer in a store is analyzed by analyzing an image generated by a camera for photographing a product held in a hand of a customer, it is possible to acquire a desired result by processing the image generated by the camera. Specifically, an image generated by the camera can be used in combination for both of settlement processing usage, and a usage of analyzing an action of a customer in a store. Consequently, a cost burden, a maintenance burden, and the like due to installation of a large number of cameras can be suppressed.

### Second Example Embodiment

A processing apparatus 10 according to a present example embodiment generates time-series information on an orientation of a product by analyzing an image generated by a camera for photographing the product held in a hand of a customer, and determines an action performed for the product (product held in the hand of the customer) by the customer, based on the time-series information on the orientation of the product. In the following, details are described.

An image analysis unit 12 generates time-series information on an orientation of a product held in a hand of a customer, based on an image. A means for determining an orientation of a product is not specifically limited, but, in the following, one example is described.

For example, an orientation of a product may be indicated by a direction in which a characteristic portion (such as a logo or a label of a product) of an external appearance of the product is directed. By adjusting a position and an orientation of a plurality of cameras for photographing a product held in a hand of a customer, it becomes possible to photograph all surfaces of the product. It is possible to compute a direction in which a characteristic portion (such as a logo or a label of a product) of an external appearance of the above-described product is directed, based on in which orientation, a characteristic portion of an external appearance of the product is captured within an image generated by which one of the cameras, or a position, an orientation, and the like of the camera.

In addition to the above, a plurality of reference images acquired by photographing a product from each of a plurality of directions may be generated in advance. Further, it is possible to compute in which direction and which portion of a product is directed, based on in which one of the above-described plurality of directions, a photographed reference image is indicated within an image generated by each camera, or a position, an orientation, and the like of a plurality of cameras.

A determination unit 13 determines, based on time-series information on an orientation of a product, whether the customer has performed a specific action for the product.

A plurality of kinds of actions which may be performed for a product held in a hand of a customer are defined in advance. Further, reference information in which a feature of a timewise change of an orientation of a product (product held in a hand of a customer) when the customer is performing each action is generated for each defined action, and stored in the processing apparatus 10. Further, in a case where “a feature of a timewise change of an orientation of a product (product held in a hand of a customer) when the customer is performing each action”, which is indicated by the above-described reference information, is included in a timewise change of an orientation of a product indicated by time-series information on an orientation of a product generated by the image analysis unit 12, the determination unit 13 determines that an action associated with the feature has been performed for the product.

For example, in a case where an orientation of a product is changed by a predetermined level (design matter) or more during a time when a movement status of the product indicated by time-series information on a position of the product satisfies a predetermined condition, the determination unit 13 may determine that a customer has performed an action of visually recognizing an external appearance of the product held in a hand of the customer.

The predetermined condition of a movement status of a product herein may be any, as far as the condition indicates a status that a large movement of a product has not occurred, and, for example, is a condition in which a moving velocity is equal to or less than a threshold value, a condition in which a change amount of a position is equal to or less than a threshold value, a condition in which a statistical value of a moving velocity of a product within a latest predetermined time is equal to or less than a threshold value, a condition in which a statistical value of a change amount of a position within a latest predetermined time is equal to or less than a threshold value, and the like. In a status that a large movement of a product has not occurred as described above, it is estimated that an action of taking out a product from a product display shelf, returning a product to a product display shelf, moving while holding a product in a hand, or putting, into a basket, a product held in a hand has not occurred.

In addition to the above, in a case where an orientation of a product is changed from a first orientation to a second orientation during a time when a movement status of a product indicated by time-series information on a position of the product satisfies the above-described predetermined condition, and thereafter, the orientation is returned to the first orientation, the determination unit 13 may determine that a customer has hesitated to determine whether to purchase the product held in a hand of the customer.

One example of a flow of processing of the processing apparatus 10 is similar to that of the first example embodiment. Specifically, in S20 in FIG. 10, the image analysis unit 12 determines a position of a product being a tracking target, and determines an orientation of the product. Further, in S21, the image analysis unit 12 registers, in time-series information on a position, the determined position of the product, and registers, in time-series information on an orientation, the determined orientation of the product.

Other configurations of the processing apparatus 10 are similar to those of the first example embodiment.

As described above, in the processing apparatus 10 according to the present example embodiment, an advantageous effect similar to that of the first example embodiment is achieved. Further, in addition to time-series information on a position of a product held in a hand of a customer, the processing apparatus 10 according to the present example embodiment in which an action of a customer in a store is analyzed by using time-series information on an orientation of the product achieves more detailed analysis.

Note that, in the present specification, “acquisition” includes at least one of “acquisition of data stored in another apparatus or a storage medium by an own apparatus (active acquisition)”, based on a user input, or based on a command of a program, for example, requesting or inquiring another apparatus and receiving, accessing to another apparatus or a storage medium and reading, and the like, “input of data to be output from another apparatus to an own apparatus (passive acquisition)”, based on a user input, or based on a command of a program, for example, receiving data to be distributed (or transmitted, push-notified, or the like), and acquiring by selecting from received data or information, and “generating new data by editing data (such as converting into a text, rearranging data, extracting a part of pieces of data, and changing a file format) and the like, and acquiring the new data”.

While the invention of the present application has been described with reference to the example embodiments (and examples), the invention of the present application is not limited to the above-described example embodiments (and examples). A configuration and details of the invention of the present application may be modified in various ways comprehensible to a person skilled in the art within the scope of the invention of the present application.

A part or all of the above-described example embodiments may also be described as the following supplementary notes, but is not limited to the following.
1. A processing apparatus including:

an acquisition unit that acquires an image of a product held in a hand of a customer;

an image analysis unit that generates time-series information on a position of the product, based on the image;

a determination unit that determines whether the customer has performed a specific action for the product, based on a movement status of the product indicated by the generated time-series information; and

a registration unit that registers that the customer has performed the specific action.
2. The processing apparatus according to supplementary note 1, wherein

the determination unit,
based on the time-series information,
   computes, as information indicating a movement status of the product,
   time-series information on a change amount of a moving velocity, an acceleration, or a position of the product,
   a statistical value of a change amount of a moving velocity, an acceleration, or a position of the product, or
   time-series information on a statistical value of a change amount of a moving velocity, an acceleration, or a position of the product for each unit time.
3. The processing apparatus according to supplementary note 2, wherein

the determination unit,
in a case where a pattern in which a first time period when a moving velocity of the product is equal to or more than a reference value holds therebetween a second time period 5 when a moving velocity of the product is less than the reference value is included in time-series information on a moving velocity of the product, determines that the customer has performed an action of visually recognizing an external appearance of the product held in the hand.
4. The processing apparatus according to supplementary note 2 or 3, wherein the determination unit,
   in a case where a pattern in which a first time period when a moving velocity of the product is equal to or more than a reference value holds therebetween a second time period when a moving velocity of the product is less than the reference value, and a length of the second time period is equal to or more than a reference value is included in time-series information on a moving velocity of the product, determines that the customer has hesitated to determine whether to purchase the product held in the hand.
5. The processing apparatus according to any one of supplementary notes 2 to 4, wherein

the determination unit,
in a case where a pattern in which a first time period when a moving velocity of the product is equal to or more than a reference value holds therebetween a second time period when a moving velocity of the product is less than the reference value is not included in time-series information on a moving velocity of the product, determines that the customer has put, into a shopping basket, the product taken out of a product display shelf without visually recognizing an external appearance.
6. The processing apparatus according to any one of supplementary notes 1 to 5, wherein

the image analysis unit generates time-series information on an orientation of the product, based on the image, and

the determination unit determines whether the customer has performed a specific action for the product, based on time-series information on an orientation of the product.
7. The processing apparatus according to supplementary note 6, wherein

the determination unit,
in a case where an orientation of the product is changed by a predetermined level or more during a time when a movement status of the product satisfies a predetermined condition, determines that the customer has performed an action of visually recognizing an external appearance of the product held in the hand.
8. The processing apparatus according to supplementary note 6 or 7, wherein

the determination unit,
in a case where an orientation of the product is changed from a first orientation to a second orientation during a time when a movement status of the product satisfies a predetermined condition, and thereafter, the orientation is returned to the first orientation, determines that the customer has hesitated to determine whether to purchase the product held in the hand.
9. A processing method including,

by a computer:

acquiring an image of a product held in a hand of a customer;

generating time-series information on a position of the product, based on the image;

determining whether the customer has performed a specific action for the product, based on a movement status of the product indicated by the generated time-series information; and

registering that the customer has performed the specific action.
10. A program causing a computer to function as: an acquisition unit that acquires an image of a product held in a hand of a customer;

an image analysis unit that generates time-series information on a position of the product, based on the image;

a determination unit that determines whether the customer has performed a specific action for the product, based on a movement status of the product indicated by the generated time-series information; and

a registration unit that registers that the customer has performed the specific action.

What is claimed is:

1. A processing apparatus comprising:
at least one memory configured to store one or more instructions; and
at least one processor configured to execute the one or more instructions to:
acquire an image of a product held in a hand of a customer;
generate time-series information on a position of the product, based on the image;
determine whether the customer has performed a specific action for the product, based on a movement status of the product indicated by the generated time-series information; and
register that the customer has performed the specific action.

2. The processing apparatus according to claim 1, wherein
the processor is further configured to execute the one or more instructions to,
based on the time-series information,
compute, as information indicating a movement status of the product,
time-series information on a change amount of a moving velocity, an acceleration, or a position of the product,
a statistical value of a change amount of a moving velocity, an acceleration, or a position of the product, or
time-series information on a statistical value of a change amount of a moving velocity, an acceleration, or a position of the product for each unit time.

3. The processing apparatus according to claim 2, wherein
the processor is further configured to execute the one or more instructions to,
in a case where a pattern in which a first time period when a moving velocity of the product is equal to or more than a reference value holds therebetween a second time period when a moving velocity of the product is less than the reference value is included in time-series information on a moving velocity of the product, determine that the customer has performed an action of visually recognizing an external appearance of the product held in the hand.

4. The processing apparatus according to claim 2, wherein
the processor is further configured to execute the one or more instructions to,
in a case where a pattern in which a first time period when a moving velocity of the product is equal to or more than a reference value holds therebetween a second time period when a moving velocity of the product is less than the reference value, and a length of the second time period is equal to or more than a reference value is included in time-series information on a moving velocity of the product, determine that the customer has hesitated to determine whether to purchase the product held in the hand.

5. The processing apparatus according to claim 2, wherein
the processor is further configured to execute the one or more instructions to,
in a case where a pattern in which a first time period when a moving velocity of the product is equal to or more than a reference value holds therebetween a second time period when a moving velocity of the product is less than the reference value is not included in time-series information on a moving velocity of the product, determine that the customer has put, into a shopping basket, the product taken out of a product display shelf without visually recognizing an external appearance.

6. The processing apparatus according to claim 1, wherein the processor is further configured to execute the one or more instructions to:
generate time-series information on an orientation of the product, based on the image, and
determine whether the customer has performed a specific action for the product, based on time-series information on an orientation of the product.

7. The processing apparatus according to claim 6, wherein
the processor is further configured to execute the one or more instructions to,
in a case where an orientation of the product is changed by a predetermined level or more during a time when a movement status of the product satisfies a predetermined condition, determine that the customer has performed an action of visually recognizing an external appearance of the product held in the hand.

8. The processing apparatus according to claim 6, wherein
the processor is further configured to execute the one or more instructions to,
in a case where an orientation of the product is changed from a first orientation to a second orientation during a time when a movement status of the product satisfies a predetermined condition, and thereafter, the orientation is returned to the first orientation, determine that the customer has hesitated to determine whether to purchase the product held in the hand.

9. A processing method comprising,
by a computer:
acquiring an image of a product held in a hand of a customer;
generating time-series information on a position of the product, based on the image;
determining whether the customer has performed a specific action for the product, based on a movement status of the product indicated by the generated time-series information; and
registering that the customer has performed the specific action.

10. A non-transitory storage medium storing a program causing a computer to:
acquire an image of a product held in a hand of a customer;
generate time-series information on a position of the product, based on the image;
determine whether the customer has performed a specific action for the product, based on a movement status of the product indicated by the generated time-series information; and
register that the customer has performed the specific action.
